(19) United States
(12) Patent Application Publication
(10) Pub. No.: US 2012/0197906 A1
(43) Pub. Date: Aug. 2, 2012

(54) Systems and methods for capturing profession recommendations, create a profession ranking

(76) Inventors: Michael Landau, Palo Alto, CA (US); Jonathan Gheller, Palo Alto, CA (US); Craig Fratrik, Palo Alto, CA (US)

(21) Appl. No.: 13/354,690

(22) Filed: Jan. 20, 2012

Related U.S. Application Data
(60) Provisional application No. 61/437,068, filed on Jan. 28, 2011.

(51) Int. Cl. G06F 17/30

(52) U.S. Cl. 707/748; 707/E17.032

(57) ABSTRACT

Systems and methods are used in a web application that analyzes a user's online presence to estimate their professional skills and those of their connections. These are used in order to ask them to decide who is better at a specific skill between two people they know. The answers are used to build a professional ranking by skill and expertise for every person

### CROSS-REFERENCE TO RELATED APPLICATIONS

This application claims the benefit of U.S. application Ser. No. 61/437,068, filed Jan. 28, 2011, which application is fully incorporated herein by reference.

### FIELD OF THE INVENTION

This invention relates generally to systems and methods directed to user contacts and contact lists, and more particularly to systems and methods that analyze a user's communications with the user's contacts, SMS or call logs, internal enterprise software such as user communications, e-mails, social network communications and the like, to create a more refined list of user contacts and a trusted network for a user that is a sub-group of the user's contacts, which includes contacts that are more relevant than mere casual contacts; and additionally provides mechanisms for introductions, references and ranking of connections, skill sets, and the like.

### DESCRIPTION OF THE RELATED ART

On-line professional recommendation services require the user to solicit a recommendation. The person who gets the request writes a recommendation which usually is shared with the people who have access to it. Other variations on this include allowing the reviewer to initiate the process without the request of the user. Moreover, some services allow that process to be anonymous so that the person who gets the recommendation does not know who provided it. Lastly, in some cases the services do not allow the user to delete or control the anonymous recommendations so the users ends with an anonymous and unsolicited recommendation on the site.

A core challenge is that requesting a recommendation is socially awkward. It is uncomfortable to deny a request. The incentive structure favors superficial and dishonest recommendations. Moreover, for the person who is reading the recommendation it is very difficult to contextualize the wording used by the reviewer. For example, when someone says “Dean is great, I would work with him again!” it is difficult to know how often and what weight the reviewer places in such phrasing and word usage. The same applies to people that a user has added. There is an incentive to reciprocate and add everyone who adds the user to their networks.

Current systems ask users of web applications and social networks for a written review. LinkedIn™ and Honestly™. Are typical recommendation systems.

Additionally, current systems and methods do not provide for a user to define their preferred connections. Current systems and methods fail to recognize that all connections are not equal. Some connections are known for lengthy periods of times such as years, while others are for hours or less.

Accordingly, there is a need for, systems and methods that provide suggestions regarding who the right people are to ask for a professional recommendation, reference or introduction. There is a further need for systems and methods that provide skill level information about individuals that is validated by others. There is yet a further need for systems and methods that provide skill level information about individuals validated by others and provide a mechanism for ranking those skills such that the professional reputation can be summarized in a number. There is another need for systems and methods that provide mechanisms to rank connections of a user by various dimensions including but not limited to professional and soft skills.

### SUMMARY OF THE INVENTION

An object of the present invention is to provide systems and methods that analyzes a user's communications with third parties.

Another object of the present invention is to provide systems and methods that analyzes a user communications with the user's contacts, SMS or call logs, internal enterprise software such as corporate communications, e-mails, social network communications and the like.

A further object of the present invention is to provide systems and methods that analyzes a user communications with the user's contacts, SMS or call logs, internal enterprise software such as corporate communications, e-mails, social network communications and the like to create a more refined list of user contacts.

Yet another object of the present invention is to provide systems and methods that create a trusted network for a user that is a sub-group of the user's contacts, which includes contacts that are more relevant than mere casual contacts.

Still another object of the present invention is to provide systems and methods that create a trusted network for a user of contacts that the user has a closer relationship with than with all of the user's contacts.

A further object of the present invention is to provide systems and methods that create a trusted network for a user that can be used to provide introductions, recommendations and referrals as well as to estimate their professional skills.

Another object of the present invention is to provide systems and methods that create a trusted network for a user which makes it easier to share contacts, receive and provide professional references, conduct background checks, decide who is better at a specific skill set and the like.

An object of the present invention is to provide systems and methods that allow a person to determine the right entities or individuals with whom to ask for a recommendation, reference, introduction or skill ranking for a specific person in a social network environment.

Another object of the present invention is to provide systems and methods that provide a person with information about skill levels of specific levels of entities or individuals in a social network environment.

A further object of the present invention is to provide systems and methods that provide a user with information about the skill levels of specific entities or individuals and a general ranking that encompasses the professional reputation of specific entities or individuals in a social network environment

A further object of the present invention is to provide systems and methods for a web application that analyzes a user's email and online presence to estimate a network of entities and individuals known by the user for whom the user can provide introductions, recommendations and referrals, rankings as well to estimate their professional skills.

Yet another object of the present invention is to provide systems and methods that analyzes a user's e-mails and online presence to ask the user's connections to decide who is better at a specific skill between different entities or individuals that the user knows.

Another object of the present invention is to provide systems and methods that indicate a network of entities and individuals a user knows and trusts and uses answers to questions to build a professional ranking by skill and expertise for individuals in that network.

These and other objects of the present invention are achieved in a method to build a list or network of user contacts. At least one of a user's, contacts, SMS or call logs, internal enterprise software, e-mails and social network communications is accessed. An analysis is performed on at lest some of the user's contacts; SMS or call logs, internal enterprise software, e-mails and social network communications. In response to performing the analysis entities and individuals are identified that the user has sufficient contact with to enable the user to provide at least one of, introductions, references, ranking of connections, knowledge of skill sets of the user contacts. A list or network of preferred user contacts is created.

### BRIEF DESCRIPTION OF THE DRAWINGS

FIG. 1 illustrates a general system diagram that depicts user interactions and backend and logic resource required at every step

FIG. 2 illustrates the criteria and flow by which all the logic resources for relationship strength come together;

FIG. 3 is a view of the interface by which questions are ask to the user on the present invention;

FIG. 4 is the mathematical formula of the probability of one user been selected over other on such questions;

FIG. 5 is the mathematical formula for the raking of the user-friendly;

FIG. 6 is the mathematical formula for the ranking of the voter;

FIG. 7 is illustrates the criteria and flow by which all the logic resources for ranking come together;

FIG. 8 illustrates a flowchart of the system architecture for the ranking;

FIG. 9 illustrates how we select the connections to serve on each question.

### DETAILED DESCRIPTION OF THE PREFERRED EMBODIMENTS

In one embodiment, the present invention is a system and method to build a list or network of user contacts. At least one of a user's, contacts, SMS or call logs, internal enterprise software, e-mails and social network communications is accessed. An analysis is performed on at lest some of the user's contacts; SMS or call logs, internal enterprise software, e-mails and social network communications. In response to performing the analysis entities and individuals are identified that the user has sufficient contact with to enable the user to provide at least one of, introductions, references, ranking of connections, knowledge of skill sets of the user contacts. A list or network of preferred user contacts is created, hereafter (“Preferred User Contacts”).

In one embodiment, the systems and methods of the present invention communicates with the Preferred User Contacts. The system and method of the present invention makes it easier to share contacts, receive and provide professional references, conduct background checks, and the like.

In one embodiment, the user's contacts include profit and non-profit businesses, service providers, government entities and individuals. In one embodiment, the user initiates the accessing. In another embodiment, a user contact initiates the accessing.

In one embodiment, the systems and methods of the present invention provides a list or network of some or all Preferred User Contacts that a user knows and trusts as a depiction of the user's trusted and real network hereafter (“Trusted Network”). This can be a subgroup of the Preferred User Contacts that the user interacts with. More particularly, the Trusted Network includes entities and individuals that the user has more than a casual relationship with, those that the user can provide introductions, references, ranking of connections, background checks, ranking of skill sets, and the like.

In some embodiments of the present invention, the system 10 uses an ontology to assign skills and ask questions relative to the skills. The user's various communications are used to determine the Trusted Network.

In order to provide appropriate questions for the Preferred User Contacts and to build the Trusted Network, the system 10 analyzes the Preferred User Contacts to extract keywords that map to a set of skills and expertise related keywords in the ontology by the system of the present invention. The ontology supports relationships like parent and child as well as synonymous. Skill assignment logic resources make the skill assignment in a time and computational efficient procedure as shown in FIG. 5. From a hardware perspective, the operation described above entails several transactions with different servers running different elements of the process, as more fully described hereafter. When the user registers using any appropriate authentication methods can be employed with the Preferred User Contacts, The system's web server pings the user's connection's API's SDKs, other authentication methods, as well as those that are input manually, and requests the input used in the system's logic resources. Once the data is returned, the web server feeds a system server that hosts all logic resources. There the data is served to the user profile index logic resource that takes on the raw data and extracts the relevant data to run the logic resource. Once the output is ready, its passes the relevant pairs to ask the user to the web server. The responses are feed back to a ranking logic resource, which resides in a logic resource server, and is then stored in a database.

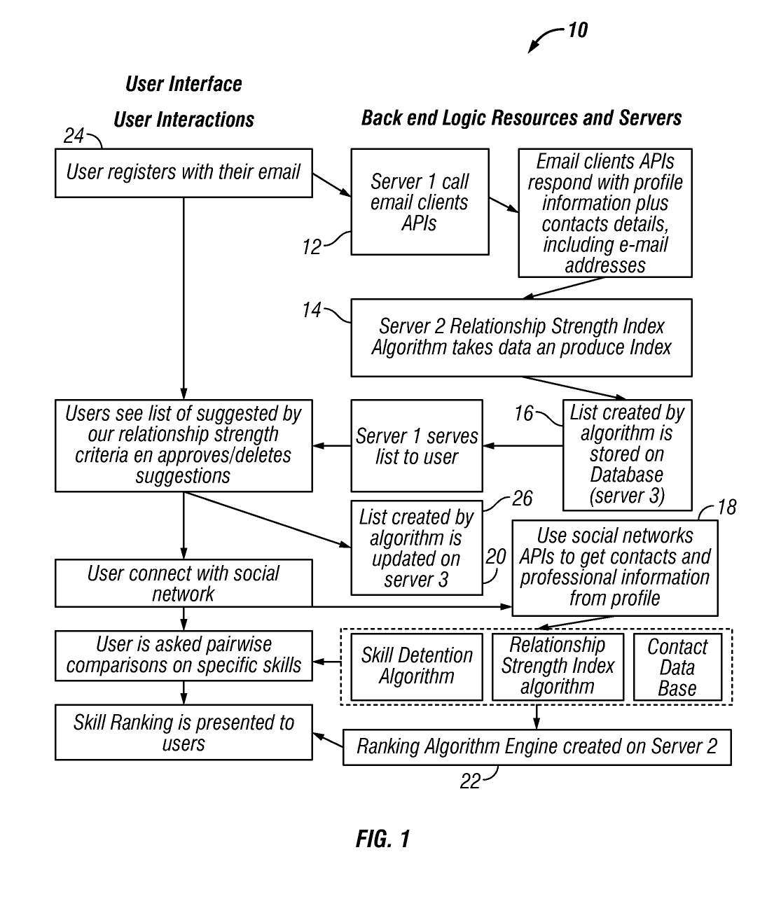

FIG. 1 illustrates one embodiment of a system of the present invention. System 10 includes first server 12, second server 14, list 16, social networks 18, third server 20 and ranking engine 22. The user first provides the system 10 with access to some or all of its user connections and registers. A variety of methods of registration can be utilized, including but not limited to, e-mail authentication such as Gmail™ Hotmail™, Outlook™, and the like, the use of social networks, as well as manually. Server 1 carries an authentication request to, as non-limiting examples, an e-mail client API social network API, a mobile OS SDK or API, an enterprise software SDK, manually gathered and the like. If the credentials provided by the user match, then the user is provided access to Preferred User Contacts.

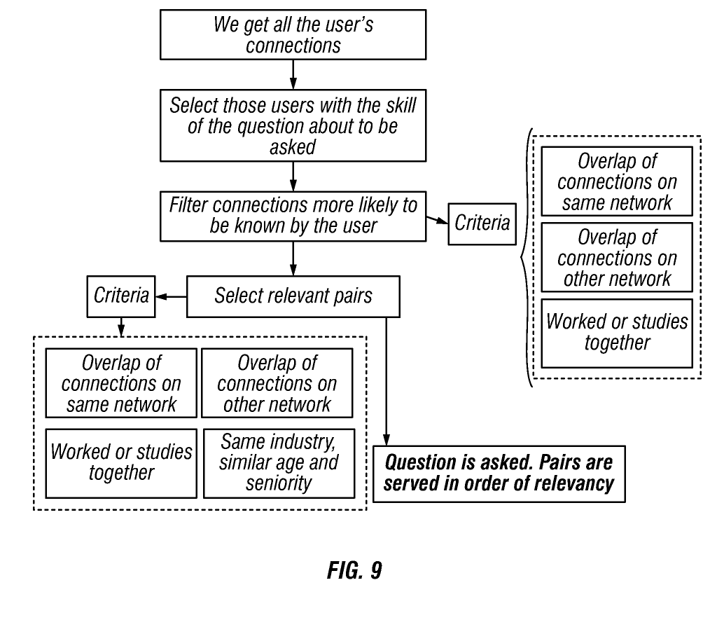

The information is then received at the second server 14 that runs all logic resources. A relationship strength logic resource receives the data and produces a relationship strength list which is stored on the third server 20. The third server 20 is a database server. The relationship strength logic resource delivers the list back to the first server 12 and a user interface 24 for approval/removal of the individuals presented on the list, as more fully illustrated in FIG. 9. Once the list is edited by the user, it is sent back to database 26 to upgrade the list which is now a list of the best connections for the user. The system 10 analyzes the communications the user has with the Preferred User Contacts and determines the closest contacts. The user is allowed access to this and can edit it.

The user or a user contact is then connected with its user connections in order for the system to create the User Contacts. A similar process takes place with the first server 12 which sends the credentials to the API's. It the credentials are correct, the first server 12 receives the list of User Contacts with the professional information as listed on the profiles.

The contact information is send to the database 20 where the information is enriched, extended or disambiguates contacts on the database 20. This includes but is not limited to, adding more information about the person, extending the information about the people in that there is an integrate of all the information that can be accessed about that person from system 10 The professional information is processed by skill assignment and detection resources, explained in greater detail hereafter. The contacts are delivered to relationship strength resources to analyze for network overlap. The relationship strength resources enrich or extend the relationship strength index.

The user is asked pair wise comparison questions which are then deliver back to the ranking resources and finally deliver back to the first server 12 to show rankings through the web interface 24 to users.

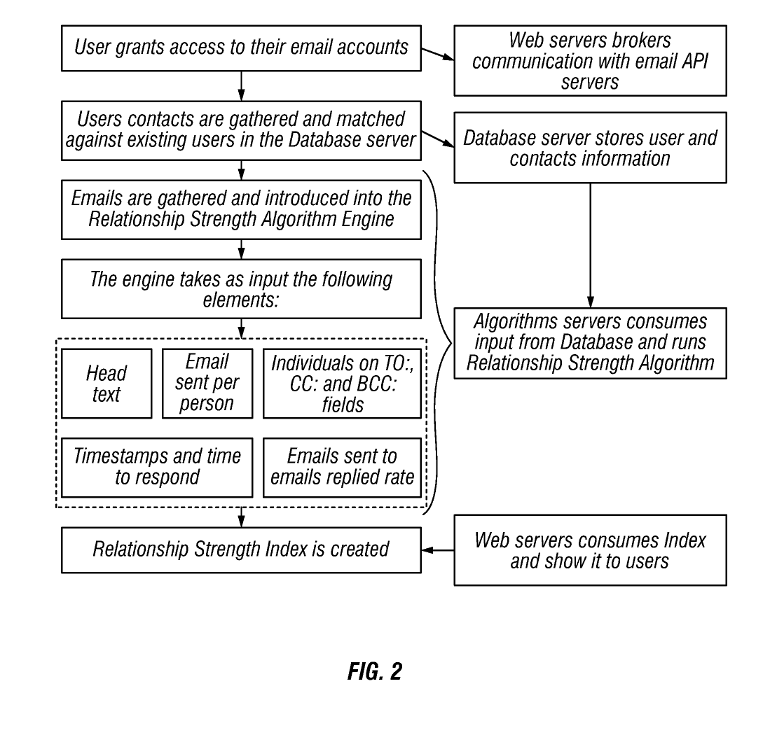

Referring now to FIG. 2, more detail is provided relative to how Information is gathered when users register using mechanisms of access with the use of the relationship strength index resources. The goal of the relationship strength index resources is to determine who are the people that the user is most likely to know and trust.

In order to create a relationship strength index there are several elements taken into consideration including but not limited to, (i) the header of the sent emails sent and received by this user, (ii) the number of emails sent per person which includes directly sent, :“cc”, or “bbc”, (iii) how quickly the user replies to emails from each of the contacts, (iv) how promptly those contacts replied to emails initiated by the users and (v) the rate of sent vs. responded email for the user as well as for the contacts.

The header of the email is used to detected the email that either addresses topics related to the skill of the user or that trigger any of the important keywords in database 20, including but not limited to, important, urgent, asap, must, now, and the like. With a facepost, what the user posts on someone's blog and how often there are postings, as well as likes and comments on those posts are used. For a professional network it can be an overlap of connections as well as overlapping work time in the same company. With phone calls it can include the topic, length, the days and frequency, SMS, calls, e-mails, internal enterprise software can be analyzed in a similar fashion. If an email is related to a user skill or if it is deemed important, then the other elements in the e-mail, including but not limited to, time to respond, and the like, can be more relevant and thus given greater weight.

The next consideration is how user communications were sent for each of the contacts of the user. As a non-limiting example, Sending more e-mails is a sign of a closer relationship. E-mails sent are normalized so that high volume is analyzed in the context of the email habits of each user. The same logic applies to SMS or call logs. In the case of social network interactions, the system 10 normalize likes, shares and comments and assess frequency and length in the case of comments, to assess the impact of the interaction. The system 10 then looks at the recipients and assumes that those in the To field are more relevant than those in the cc field, and those are more relevant than the recipients in the bcc field. In this manner, many emails sent to someone as cc contribute less to the relationship strength than those sent to people in the “To” field. Other considerations include but are not limited to, the last communications organized by time, how often people talked and how recent they were. The system 10 also looks at whether a communication has been market as urgent explicitly or implicitly by looking at keywords including but not limited to, “urgent”, “asap”, “important”.

How quickly a user replies to e-mails sent is also used as a signal to determine relationship strength. The faster the user replied the greater the importance is given to the person that the user replied to. As with email volume, speed of reply is also normalized so that is catered to the email habits of the user. The relationship strength index resources takes into account emails that are not replied to, both sent or received by the user. The volume is once again normalized and a ratio created.

With the present invention, users register with the system 10 using their user communication credentials including but not limited to e-mail credentials, social network credentials, profit or non-profit business communication system credentials, mobile phone SDK granted credentials, manually inputted and the like as discussed above, to determine if the user is a Trusted Network. The user is then asked to confirm the quality of the created Trusted Network and modify it if needed.

As a non-limiting example, for each individual desiring an introduction, recommendation or reference of someone else, and the like the system 10 provides a created list of recommended people. Additionally, the system allows users to rate their contacts by skills to create a ranking that depicts the individual professional reputation.

Users skills can be obtained by a variety of different ways including but not limited to asking them directly. Other methods include detecting skills from users social network profiles as well as by the topics of the conversation in emails. In both cases text would be mined and mapped against the system's skills ontology. When there is a connection of user skills, of the skills are related in or to the ontology. As non-limiting examples, a medical doctor can have an informed opinion of a dentist, a product manager of a software developer, and the like. Their User Contacts accounts are accessed and a determination of the skills of the users and of their contacts.

With the skills assigned, the system 10 allows users to rank connections in skills that are relevant to them. Relevance is assigned using a skill ontology.

The system 10 weighs the votes received by the votes. The votes are the decision of the user when asked for a specific skill comparison between two or more individuals. The votes also include the current ranking of individuals compared and the system's data for estimations of relationship strength to weight the votes and obtain a normalized ranking. When a ranking is available, users can get access to it and use it to educate introductions, references and recommendations. The rankings are shared in order to provide a strong indication of people's skills. A search can be conducted of skills along with an ordering of individuals with those skills.

With regard to a reference, one receives not only the subjective opinion or two or more individuals, but also an aggregated opinion in the form of a standardized, high signal and comparable ranking.

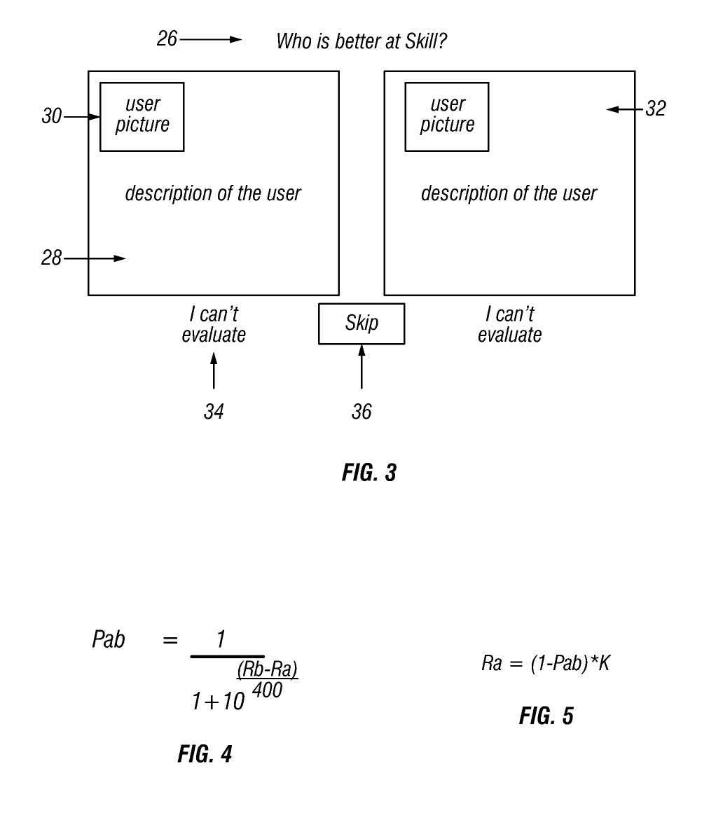

FIG. 3 illustrates a query posted to the user regarding a skill that is relevant to the user. The query asked can be, who is better at a specific skill between two people. The question is presented on 26. 28 and 32 are the container for each of the individuals the user can choose to vote on. By clicking on 28 or 32 the user is either voting on one or the other 30 is the picture of the user. Notice that there is a picture as well as a description of the user both inside 28 as well as 32. The user can decide in 34 that he or she cannot evaluate the user. Reasons might include that the user does not know the person or that the person is not relevant for that skill. Finally, the user can decide on 36 to skip the question at which point the system would serve another question. As a way of an example, one of such questions could be “who is a better Product Manager?”.

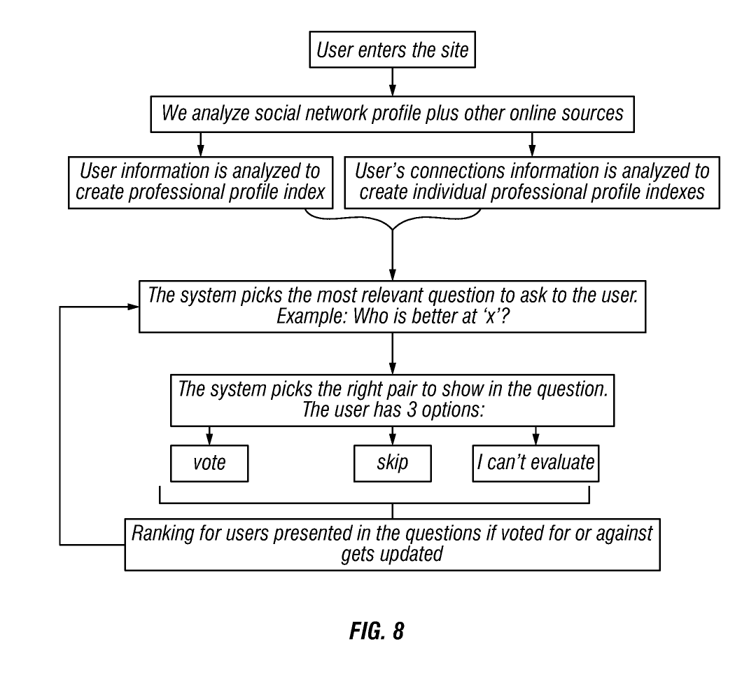

Referring to the system architecture of FIG. 8, once a user comes into the site they are assigned several skills. Those skills are mapped to an ontology that cover several hundred professions and specialties including but not limited to, programming languages such as like Java , PHP and the like, final related roles such as venture capitalist or Investment Banker and professions, dentist, cardiologist, corporate lawyer, and the like. The question posed by the systems and methods of the present invention is a function of the relevancy of the skills for that user. As a non-limiting example, someone could be a software engineer and a chef and the systems and methods of the present invention ask questions about these two skills and are then sorted by relevancy. As a non-limiting example, questions for such skills can be “who is a better software engineer?”, “who is a better chef?” and the like. The syntax and phrasing of the question is made to fit each skill appropriately.

The systems and methods of the present invention apply several logic resources to decide what questions to ask the user as well as which persons to serve on those questions. These logic resources are explained below and illustrated in FIG. 5.

As a non-limiting example, the process starts by taking each keyword on every user page, including but not limited to their LinkedIn™ profile, Facebook™ profile or some other publicly available site or available via the permission of the user using the API of third party platforms, and look for that keyword or a synonymous of that keyword on the system's ontology.

Once the keyword is found, the position of the skill on the ontology tree allows the system 10 to assign parent skills to the user. For example, if the systems and methods of the present invention determine that a user is a Java programmer the systems and methods of the present invention know he is also a software engineer because Java is a child skill of Software engineering.

In order to determine the importance of the skill for the user the system 10 examines the place where the keyword is captured. If the keyword appears in a comment someone wrote on the user profile, that is far less relevant that if the user uses the keyword on a field of the page used for self description.

Skill questionnaire logic resources applied establishes the criteria for deciding which persons to serve on the question. The skill questionnaire logic resources uses the user profile index, the logic resource strength logic resources and takes into account people that the user share as connection or friend in a social network like Facebook™ and Linkedin™ but not limited to those sources. The system 10 analyzes and assigns skills to these people the same way the system 10 did to the user. Additionally, the system 10 optimizes pairs so that the comparison is one that a user can form on opinion on. The system 10 can make sure through job titles and seniority that a comparison is made between people with similar professional profiles.

FIG. 7 illustrates in a flow chart the process just described. As a way of an example: if the user is a business development expert the system 10 only selects people among the user's connections that the system 10 believes are business development experts. From these, the system 10 selects those that either share many connections with the user or share several other relevant contacts with the user. Having worked together or gone to the same school is one method that can be utilized. Once the pool is reduced to a list of those more likely to be known by the user, the system 10 then pairs them to make sure age differences and seniority are within a small range to make sure the people are comparable. For example, it would not be desirable to compare a 20 year old professional with a 50 year professional. The reason being that the age difference is very likely to be an indicative of different levels of experience and for a comparison to yield meaningful data it must provide options that are alternatives in real life for a specific job.

The same is true for seniority levels. It is not desirable to compare a senior vice president of sales with a sales intern because in real life those two individuals are not valid options for the same job position. The system 10 clusters seniority levels to make sure people in higher management are compared with people in higher management and those in entry level positions are compared with similar people.

Other criteria, including but not limited to the same industry expertise or similar work location can also used.

The same applies for relationship strength. It is less desirable to compare people know for a couple of days with people know for several years. The social network itself does not provide this information. However, with the present invention, access is provided to the Preferred User Contacts and the creation of a Trusted Network. The present invention utilizes the frequency of communication as a proxy as to how well they know each other, as distinguished from just accessing a social network., as illustrated in FIGS. 8 and 9. In one embodiment, the system 10 gathers a reliable proxy of relationship strength that compares individuals with comparable relationship strengths.

All or every data point, from skill assignment to the user location or last job title is weighted by the likelihood that the systems and methods of the present invention have captured the right data for each user.

In one embodiment, there are two main elements that go into the ranking; the ranking of the voter for the specific skill that he voted on and the relative ranking of the person compared against.

In the first element the higher the ranking of a person for that skill, the more impact this person vote would have both on the individual voted in favor as well as the person voted against. In this way we use the voter ranking as a proxy for their adequacy to determine who is good at that specific skill.

The second element takes into account the relative, comparative nature of the voting mechanism. That way, winning a vote against a lower ranked person adds less to that winner ranking than winning against someone with a high ranking. “High” and “low” in this case refer specifically to the ranking of one of the compared people with regards to the ranking of the other.

In another embodiment, there are primarily three elements of the weighting logic resource. In this embodiment, the first element assess the likelihood that a person has the skills for each that has been benchmarked The second element assess the likelihood that the voter knows the person being benchmarked. The element assess the adequacy of the comparison. Four criteria can be used in deciding how much weight to give a vote. The first two are directed to the level of skill, voter and user compared. The other two are directed to the accuracy of the question, e.g., do I have the right skills to judge, do I know the person.

The first element takes into account the keyword density of the skills as it appears on the profile of the user as well as where on the profile it appears. Low keyword density lowers the confidence of the logic resource that the person in fact has that skills and through machine learning established thresholds a certain density is needed to qualify the assignment of the skill. With regards to the location, the user profile index resources weigh more skills mentioned in a present job description than in past ones. Someone who was an accountant 20 years ago but has been a chef since then until now would be more likely to appear on chef related questions than on accountant related questions.

The second element assesses relationship strength. Network overlap data is used as a proxy. More importantly, the relationship strength index created by analyzing e-mails as well as other User Contacts, is an important input for this goal, see FIGS. 8 and 9.

The last element assesses the adequacy of the comparison. The first and the second elements are weighted with the feedback of users who tell the system 10 if they know the person asked on or if the skill is relevant for that person using a variety of different methods including but not limited to, a linear regression machine learning model, logistic regression, ML base algorithms, and the like. These are used to adjust the likelihood of two individuals being compared together in a question on a specific skill.

The third logic resource processes the votes given by all the users in the system to calculate a ranking. The third logic resource takes into account the relevancy of the voter as well as the relevancy of the people compared in the question to assign a weight to the vote. The result is then aggregated and normalized to calculate a ranking from one to ten which then is expressed in an orderly number starting at one and finishing with the total number of people analyzed or as a percentile.

The rationale behind assigning weight to votes is the following: if someone with a great reputation votes or endorses someone, that opinion should carry more weight that if the person voting carries no reputation. Also, if the person someone is being compared to has a very low professional reputation, the vote in favor should count very little because it is very likely that that person would win. On the other hand, if someone looses against someone with low reputation, that affects his rankings materially in a negative way.

In order to assess the relevancy of the voter as well as the people compared the system 10 makes use of a function based on a modification of the rating system.

This is the logic behind the function. For every question the system 10 serves to a person, the system 10 assigns a probability of winning to both individuals who appear as options on vote on the question.

In one embodiment, the process works as follows. At the start the system assumes that everyone has the same probability of being good at a particular skill and hence the same probability of winning when compared with someone else on a question. As a non-limiting example, when person ‘a’ wins over person ‘b’ the present invention adjusts ‘a’ probability of winning over ‘a’ (and hence ‘b’ probability of loosing over ‘a’). The next time ‘a’ shows in a question, he has a higher probability of being the winner than he had before getting the vote, and ‘b’ has a lower probability of being the winner that he had on the initial stage. Additionally, when ‘a’ or ‘b’ vote for someone else, the impact on that person's ranking is different than it was on the initial stage: ‘a’ vote is has a higher impact on the ranking of the people he votes for or against then ‘b”s vote.

Every time after the vote takes place, the probabilities are adjusted. The ranking of the person in turn is a reflection of that probability of winning to anyone on the system.

As a non-limiting example, when the present invention serves person ‘a’ and person ‘b’, the probability of a winning over b is calculated by dividing 1 by 1 plus 1 elevated to the ranking of ‘b’ minus the ranking of “divided by 400. The equation can be found on FIG. 4.

The ranking of each user then can be found on FIG. 5. The ranking of a is 1 minus the probability of ‘a’ winning against ‘b’, multiplied by ‘K’. In FIG. 5, ‘K’ is the weight assigned to the voter.

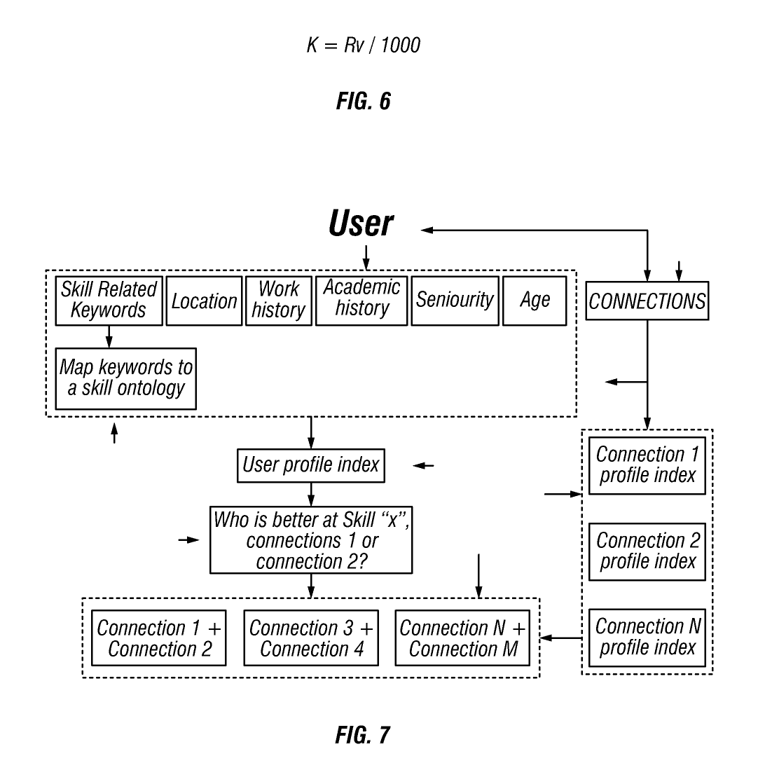

FIG. 6 shows how that weight is calculated where Rv is then the ranking of the voter.

FIG. 5 revisits the logic resource to asking skills, questions and the people the present invention shows on questions and puts all of these elements in a flow diagram. The first step is to get the user into the systems of the present invention. The present invention looks for keywords that can map back to the skill ontology utilized by the systems and methods of the present invention. This allow the systems of the present invention to make educated guesses as to the skill needed to assign to them. The present invention also analyzes location, work history, academic history seniority and age. The present invention does the same process as depicted on 2 for the user's connections. With this information the present invention calculates a profile index both for out users, FIG. 3, and for each of the user's connections (see 4). The index is a unique identifier that encompasses all this dimensions weighted by relevancy. It is this index that allows us to assess how relevant is asking a user about one of his or her connections for a specific skill.

The system 10 then makes pairs out of the total pool of user's connections that are relevant for the skill for which the present invention will be asking a question. The relevance of these pairs, as illustrated in FIG. 5. is assed by the same variables as those from which the profile index is calculated. The goal is to ask questions that show “balanced” pairs. As a non-limiting example, the present invention may want to ask questions about people in the same industry or who have the same seniority.

Once the best pair is selected, the present invention is ready to ask the questions. The system 10 serves as many questions available and they can be ordered by the most adequate pairs first.

FIG. 6 illustrates a general system architecture flow chart. In it, the system 10 explains how the overall user flow works from coming into the site to answer questions that serve as recommendation on the site. The present invention also explains how that impacts other people for whom the present invention is building a ranking.

Other embodiments of the present invention will be apparent to those skilled in the art from consideration of the specification and practice of the invention disclosed herein. It is intended that the specification and examples be considered as exemplary only.

1. A method to build a list or network of user contacts, comprising:
accessing at least one of a user's, contacts, SMS or call logs, internal enterprise software, e-mails and social network communications;
performing an analysis of the at lest some of the user's contacts; SMS or call logs, internal enterprise software, e-mails and social network communications
in response to performing the analysis identifying entities and individuals that the user has sufficient contact with to enable the user to provide at least one of, introductions, references, ranking of connections, knowledge of skill sets of the user contacts; and
creating a list or network of preferred user contacts.

2. The method of claim 1, wherein the user's contacts include profit and non-profit businesses, service providers, government entities and individuals.

3. The method of claim 1, wherein the user initiates the accessing.

4. The method of claim 1, wherein a user contact initiates the accessing.

5. The method of claim 1, further comprising:
creating a trusted network from the list or network of preferred user contacts.

6. The method of claim 5, wherein the trusted network is a sub-group of the list or network of preferred user contacts.

7. The method of claim 6, wherein the trusted network include user contacts that the user knows and trusts.

8. The method of claim 5, wherein the trusted network includes user contacts that the user has a real relationship with that is more than a casual relationship.

9. The method of claim 5, further comprising:
using the trusted network to build a ranking of one or more skill sets of at least a portion of the preferred user contacts in the trusted network.

10. The method of claim 5, further comprising:
analyzing the list or network of preferred user contacts to extract keywords that map to a set of skills and expertise related keywords to create a list of entities and individuals with selected skills.

11. The method of claim 10, further comprising:
allowing the user to provide input relative to the list of entities and individuals with selected skills.

12. The method of claim 1, further comprising:
building a professional ranking by skill and expertise for at least a portion of the list or network of preferred user contacts.

13. The method of claim 1, further comprising:
providing questions to the user's contacts.

14. The method of claim 13, further comprising:
receiving answers to the questions from the user's contacts.

15. The method of claim 14, further comprising:
analyzing the answers to extract keywords that map to a set of skills or expertise.

16. The method of claim 1, further comprising:
analyzing user contact's on-line presence.

17. The method of claim 16, wherein the analyzing of the on-line presence includes extraction of keywords that map to a set of skills and expertise.

18. The method of claim 15, further comprising:
using skill assignment resources.

19. The method of claim 1, further comprising:
using a plurality of servers to create the list or network of preferred user contacts.

20. The method of claim 1, further comprising:
registering the user with an appropriate authentication method to access at least a portion of the user's contacts.

21. The method of claim 1, further comprising:
providing a system that pings the users connection's API's.

22. The method of claim 21, further comprising:
carrying an authentication request to an e-mail client API.

23. The method of claim 1, further comprising:
receiving data about the user's connections; and
using a profile index logic resource that takes on the received data and extract relevant data.

24. The method of claim 23, further comprising:
creating relevant pairs;
passing the relevant pairs to the user.

25. The method of claim 24, further comprising:
receiving input from the user relative to the relevant pairs.

26. The method of claim 25, further comprising:
using a ranking logic resource to process the input from the user relative to the relevant pairs

27. The method of claim 1, further comprising:
analyzing communications the user has with the user contacts.

28. The method of claim 27, further comprising:
using a relationship strength logic resource relative to analyzing the communications.

29. The method of claim 1, further comprising:
carrying an authentication request to an e-mail client API.

30. The method of claim 1, further comprising:
determining if the credentials provided by the user match credentials registered with the system.

31. The method of claim 1, further comprising:
in response to the credentials matching, granting access to the user's, contacts, SMS or call logs, internal enterprise software, e-mails and social network communications.

32. The method of claim 1, further comprising:
producing a relationship strength list; and
storing the relationship strength list.

33. The method of claim 32, further comprising:
delivering the relationship strength list to the user for editing.

34. The method of claim 33, wherein the editing includes at least one of approval and removal of entities or individuals presented on the list.

35. The method of claim 33, further comprising:
sending an edited list to a database to create an upgraded list.

36. The method of claim 35, wherein the upgraded list contains the best connections for the user or a third party relative to one or more identified traits.

37. The method of claim 36, further comprising:
connecting the user with its social network accounts.

38. The method of claim 36, further comprising:
sending the credentials to the user's social network API's.

39. The method of claim 38, further comprising:
receiving a list of contacts with professional information as listed on the profiles.

40. The method of claim 39, further comprising:
sending the contact information to the database; and
wherein the list of contacts is enriched, extended or disambiguated

41. The method of claim 40, further comprising:
processing professional information of the list of contacts.

42. The method of claim 41, further comprising:
analyzing the list of contacts for network overlap; and
enriching or extending a relationship strength index.

43. A system for creating a list or network of preferred users for a user, comprising:
a first server for accessing at least some of a user's contacts; a second server that includes relationship strength index resources that receives data from the first server and produces an index Identifying at least some individuals in user contacts that have one or more identified traits selected by the user and creates a first list of user contact;
a second server configured to creating a list or network of preferred user contacts from at least a portion of the identified individuals that have the one or more identified traits;
a third server that is a database server that includes a database; and
a user profile index, ranking logic resources, a logic resources server, relationship strength logic resource and a relationship strength list.
